(19) United States
(12) Patent Application Publication
(10) Pub. No.: US 2010/0202078 A1
(43) Pub. Date: Aug. 12, 2010

(54) READ/WRITE PROCESSING METHOD FOR MEDIUM RECORDING DEVICE AND MEDIUM RECORDING DEVICE

(75) Inventor: Noriyuki SATO, Hamura-shi (JP)

Correspondence Address: KNOBBE MARTENS OLSON & BEAR LLP, 2040 MAIN STREET, FOURTEENTH FLOOR, IRVINE, CA, 92614, US

(73) Assignee: TOSHIBA STORAGE DEVICE CORPORATION, Tokyo (JP)

(21) Appl. No.: 12/761,317

(22) Filed: Apr. 15, 2010

Related U.S. Application Data
(63) Continuation of application No. PCT/JP2007/001130, filed on Oct. 17, 2007.

(51) Int. Cl. G11B 27/36

(52) U.S. Cl. 360/31; G9B/27.052

(57) ABSTRACT

According to one embodiment, a medium recording device includes a reading/writing module configured to read/write data from/to a recording medium, a buffer memory configured to temporarily store the read data and data from a host, and a controlling circuit configured to, in response to a read command, read data from the buffer memory or the recording medium to transfer the data to the host, and in response to a write command, to store data from the host in the buffer memory, to write the data onto the recording medium, and to execute a write retry when writing fails. The controller circuit recognizes a read command issued by the host at a fixed interval for replaying continuous data, and determines whether write in response to a write command received during the replaying is likely to fail, and when the write is likely to fail, permits a reception of the read command issued at the fixed interval.

### CROSS-REFERENCE TO RELATED APPLICATIONS

This application is a continuation of PCT international application Ser. No. PCT/JP2007/001130 filed on Oct. 17, 2007 which designates the United States, the entire contents of which are incorporated herein by reference.

### BACKGROUND

1. Field

One embodiment of the invention relates to a medium recording device having a head for reading and writing data from and onto a medium, and to a read/write processing method for the medium recording device, and more particularly, to a medium recording device that periodically receives read commands for music or video data from an external device, and a read/write processing method for the medium recording device.

2. Description of the Related Art

A medium recording device such as a magnetic disk device or an optical disk device has a head for reading and writing data from and onto a medium, and such a medium recording device stores therein the data, reads the data, and replays the data stored therein. Recently, such a medium recording device is used for storing music or video data. Such a medium recording device is connected to a host, such as a personal computer, and the host also uses the medium recording device as a recording device thereof. As illustrated in FIG. 9, a medium recording device 110 such as a hard disk drive (HDD) is internally or externally connected to a host 100, such as a personal computer or a mobile computer.

When music replay is clicked on the host 100, the host 100 reads music data stored in the medium recording device 110. At this time, as illustrated in FIG. 10, the host 100 issues read commands to the medium recording device 110 and receives a piece of music data and a status STS from the medium recording device 110 for each of the read commands to replay music at a fixed interval.

In other words, because music or a video changes over time, if the host 100 is to read data for a desired piece of music all at once, the host 100 needs to have a memory capacity that can store that much data. Therefore, the music data are sequentially requested in pieces.

The host 100 also uses the medium recording device 110 as a recording device for host processes. For example, there are situations where the host 100 is running and processing another application while replaying a piece of music. In such a scenario, the application process may issue a data copy command, and, in response thereto, the host 100 may be caused to issue a write command to the medium recording device 110.

To process the write, the medium recording device 110 stores received write data in a cache memory (or buffer memory), and then writes the data onto the medium using the head. If the write fails, the medium recording device 110 reads the write data from the cache memory again, and attempts to write the data onto the medium again using the head (this process is referred to as a write retry). Such a write failure may occur due to vibrations externally applied to the device, or an environmental change such as a temperature change.

When the medium recording device 110 experiences vibrations and the like, no matter how many times the write retry is repeated, the write operation may keep failing until the vibrations applied to the medium recording device 110 stop. In response to this issue, in an environment where a possible cause of a write failure, e.g., vibrations, is present, it has been suggested to save the write data stored in the cache memory onto another semiconductor memory without executing the write retry any further, and to write the write data saved in the semiconductor memory onto the medium using the head when the possible cause of the write failure, e.g., vibrations, is removed (for example, see Japanese Patent Application Publication (KOKAI) No. 2006-269006 and Japanese Patent Application Publication (KOKAI) No. 2004-173244).

The write retry keeps a host command waiting. As illustrated in FIG. 11, if the host 100 issues a read command R1 to the medium recording device 110, the medium recording device 110 reads the music data from the requested number of sectors in the medium, stores the data in the cache memory, and transfers the data to the host 100. If the host 100 subsequently issues write commands W1 and W2 to the medium recording device 110, the medium recording device 110 stores the write data received from the host 100 in the cache memory, and writes the data onto the medium using the head.

At this time, if the write fails due to vibrations or the like, a write retry is attempted. If the host 100 is also running a music or a video replaying application, the music or the video replaying application issues read commands for music data or the like at a fixed interval, as explained earlier with reference to FIG. 10, regardless of the presence of the write process.

However, if a write command is issued in an environment where vibrations often occur, the buffer may become full or unable to report the status to the host. This leads to the buffer not being able to accept the read commands issued by the host 100 at a fixed interval.

Because, as illustrated in FIG. 11, the host 100 cannot issue a read command until the write process is completed, the sound jumps while music is replayed, and the video stops while a video is replayed.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary schematic of a configuration of a medium recording device according to one embodiment of the invention;

FIG. 2 is an exemplary flowchart of a first embodiment of a music replay recognizing process performed in the medium recording device as illustrated in FIG. 1;

FIG. 3 is an exemplary flowchart of a second embodiment of the music replay recognizing process performed in the medium recording device as illustrated in FIG. 1;

FIG. 4 is an exemplary flowchart of a third embodiment of the music replay recognizing process performed in the medium recording device as illustrated in FIG. 1;

FIG. 5 is an exemplary flowchart of a first embodiment of a read/write process performed in the medium recording device as illustrated in FIG. 1;

FIG. 6 is an exemplary schematic of the read/write process illustrated in FIG. 5;

FIG. 7 is an exemplary flowchart of a second embodiment of the read/write process performed in the medium recording device as illustrated in FIG. 1;

FIG. 8 is an exemplary schematic of the read/write process illustrated in FIG. 7;

FIG. 9 is an exemplary schematic of a configuration of a conventional system;

FIG. 10 is an exemplary schematic of timing at which a read command is issued in music replay in the configuration illustrated in FIG. 9; and

FIG. 11 is an exemplary schematic of a problem that occurs when a write is executed while music is replayed in the system illustrated in FIG. 9.

### DETAILED DESCRIPTION

Various embodiments according to the invention will be described hereinafter with reference to the accompanying drawings. In general, according to one embodiment of the invention, a medium recording device comprises: a reading/writing module configured to read and write data from and to a recording medium; a buffer memory configured to temporarily store therein data read by the reading/writing module and data to be written received from a host; and a controlling circuit configured to, in response to a read command, read data from the buffer memory or from the recording medium and to transfer the data to the host, and in response to a write command issued by the host, to store data sent from the host in the buffer memory, then to write the data onto the recording medium, and when writing fails, to execute a write retry, wherein the controller circuit recognizes, by way of the read command thus received, that the read command is a read command issued by the host at a fixed interval for replaying continuous data, and determines whether write in response to a write command received during the replaying is likely to fail in write processing, and when the write is likely to fail, permits a reception of the read command issued at the fixed interval.

According to another embodiment of the invention, a read/write processing method for a medium recording device, the method comprises: in response to a read command issued by a host, reading data from a buffer memory, or causing a medium reading/writing module to read data from a recording medium, and transferring the data to the host; in response to a write command issued by the host, storing data received from the host in the buffer memory, and then causing the medium reading/writing module to write the data onto the recording medium, and executing a write retry when write fails; recognizing, by way of the read command thus received, that the read command is a read command issued by the host at a fixed interval for replaying continuous data; determining whether write in response to a write command that is received during the replaying is likely to fail in write processing; and when the write is likely to fail, permitting a reception of the read command issued at the fixed interval.

Embodiments of the invention will now be explained in the order of: a medium recording device, a music replay recognizing process, and first and second embodiments of a read/write process; and other possible embodiments. However, the embodiments disclosed herein are not intended to limit the scope of the invention in any way.

Medium Recording Device

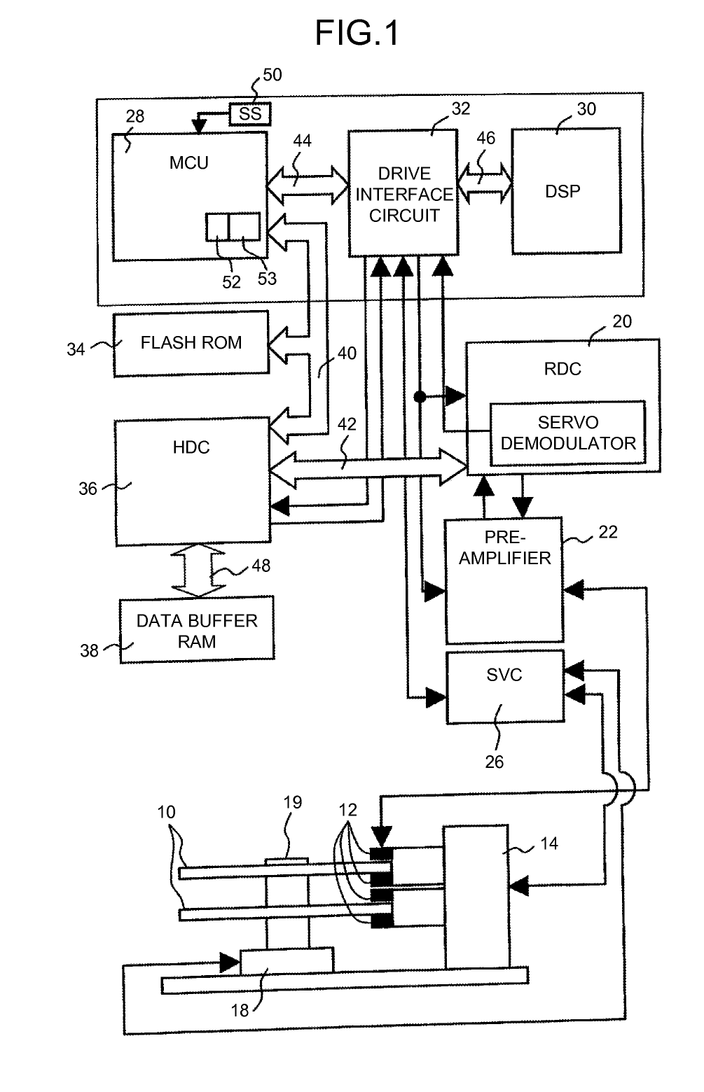

FIG. 1 is a schematic of a configuration of a medium recording device according to one embodiment of the invention, and illustrates the medium recording device as a magnetic disk device. As illustrated in FIG. 1, a magnetic disk 10 that is a magnetic recording medium is arranged on a rotation axis 19 of a spindle motor 18. The spindle motor 18 rotates the magnetic disk 10. A magnetic head 12 is arranged at an end of an actuator (voice coil motor (VCM)) 14. The actuator 14 moves the magnetic head 12 in the radial direction of the magnetic disk 10.

The actuator 14 is a VCM that rotates around a rotation axis. In FIG. 1, the magnetic disk device comprises two of the magnetic disks 10, and the same actuator 14 drives four of the magnetic heads 12 simultaneously.

The magnetic head 12 comprises a read device and a write device. The read device comprising a magneto resistive (MR) device is layered on a slider, and the write device comprising a write coil is layered further thereon.

A preamplifier 22 sends a write signal to the magnetic head 12, and amplifies a read signal received from the magnetic head 12. A servo combo circuit (SVC) 26 drives the spindle motor 18, and also supplies a driving current to the actuator 14 to drive the actuator 14.

A read channel circuit (RDC) 20 demodulates a servo signal that is one of the read signals received from the preamplifier 22 to find the position of the magnetic head 12. A controller comprises a micro controller unit (MCU) 28, and a digital signal processor (DSP) 30, and a drive interface circuit 32.

The DSP 30 detects the current position of the magnetic head 12 based on the demodulated position received from the RDC 20, and calculates a value for a VCM driving command based on an error between the detected current position and a target position. In other words, the DSP 30 performs a servo control comprising seek and track-following.

The MCU 28 comprises a micro processing unit (MPU), a read-only memory (ROM), and a random access memory (RAM). The ROM stores therein control programs for the MPU and the like. The RAM stores therein data and the like for MPU processes. The MCU 28 performs a music replay recognizing process, a read/write process, and a retry process to be described later.

The drive interface circuit 32 functions as a bridge between a drive-side circuits (the RDC 20, the preamplifier 22, and the servo combo circuit 26), and the MCU 28 and the DSP 30. The drive interface circuit 32 is connected to the MCU 28 over a first internal bus 44, and is connected to the DSP 30 over a second internal bus 46.

A flash ROM 34 stores therein boot programs such as a microcode. A hard disk controller (HDC) 36 determines a position in a track based on a sector number in the servo signal, and instructs the RDC 20 to record or replay data.

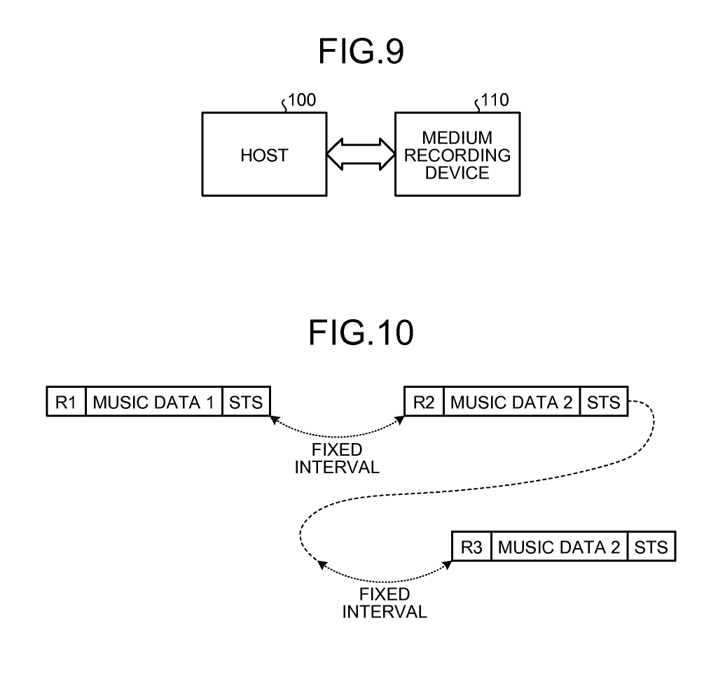

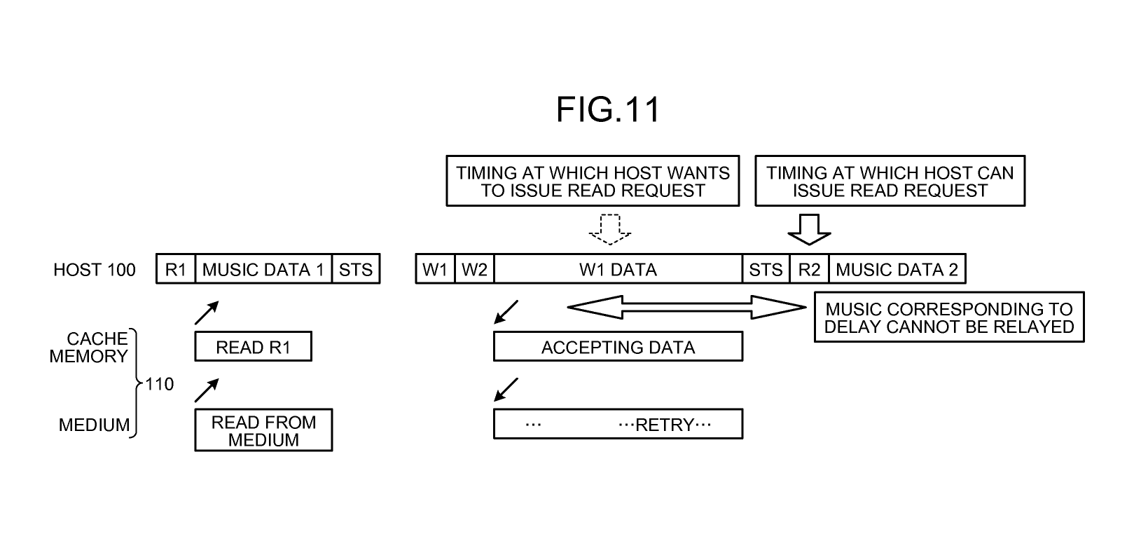

A buffer memory (data buffer RAM) 38 is connected to the HDC 36 via a memory bus 48, and temporarily stores therein read data or write data. The HDC 36 communicates with the host 100 (see FIG. 9) over an interface IF such as the Serial AT Attached (SATA) or the Small Computer System Interface (SCSI). A bus 40 connects the MCU 28, the flash ROM 34, and the HDC 36. The HDC 36 is also connected to the RDC 20 via a data bus 42 to exchange read and write data.

In the configuration illustrated in FIG. 1, the HDC 36 is responsible for exchanging data with the host 100 and the drive; the DSP 30 is responsible for seek and track-following control of the magnetic head 12; and the MCU 28 is responsible for controlling each of the modules based on a received command.

A shock sensor (SS) 50 for detecting vibration is connected to the MCU 28, and the MCU 28 detects vibrations applied to the device based on an output from the shock sensor 50. The MCU 28 comprises a music replaying flag 52 that is set when a music replay mode is detected; and a history storage area 53 that stores therein a history of receiving vibrations or a retry.

In a usual read, when the HDC 36 receives a command issued by the host 100, the HDC 36 or the MCU 28 analyzes the command. As a result of the analysis, if it is determined that the command is a read command, the HDC 36 further determines if the data to be read by the read command is cached in the buffer memory 38. If the data is cached, the HDC 36 transfers the data in the buffer memory 38 to the host 100.

If the data to be read is not cached in the buffer memory 38, the HDC 36 requests the MCU 28 to read the data from the medium. In response to the request, the MCU 28 further requests the DSP 30 to seek the sector where the data to be read is stored using the head. The DSP 30 servo-controls the actuator 14 via the servo combo circuit 26, and positions the magnetic head 12 to the target track on the magnetic disk 10.

Upon completing positioning, the RDC 20 modulates the read output from the magnetic head 12 (read device), and transfers the read data to the HDC 36. The HDC 36 stores the read, transferred data in the buffer memory 38. When the buffer memory 38 has a read cache function, the buffer memory 38 stores therein not only the data read from the sector requested by the read command, but also the data in the following sector. The HDC 36 extracts the requested data from the read data stored in the buffer memory 38, and transfers the data to the host 100.

If the analysis indicated that the command is a write command, the HDC 36 receives the write data subsequent to the command from the host 100, and stores the write data in the buffer memory 38. Based on an instruction from the MCU 28, a write is executed onto the magnetic disk 10. In other words, the MCU 28 requests the DSP 30 to seek the sector onto which the data is to be written using the head. The DSP 30 servo-controls the actuator 14 via the servo combo circuit 26, and positions the magnetic head 12 to the target track on the magnetic disk 10.

Upon completing positioning, the HDC 36 transfers the write data to the RDC 20. The RDC 20 appends the error-correcting code (ECC) and the like to the write data, and applies a write current corresponding to the write data to the magnetic head 12 (write device) via the preamplifier 22. In this manner, the write data is written onto the target sector of the magnetic disk 10.

During the write process, the MCU 28 monitors a vibration detection signal received from the shock sensor 50, and the DSP 30 monitors an error in the positioning of the magnetic head 12. If the MCU 28 detects vibrations equal to or stronger than a predetermined threshold, or if the DSP 30 detects a positioning error equal to or more than a predetermined value, the MCU 28 determines that the write fails, and stops the write process.

After the MCU 28 stops the write process, the MCU 28 executes a write retry. In the write retry, the MCU 28 executes the write process again. If the write process does not succeed even if the write retry is executed for a predetermined number of times, the host 100 is notified of an error.

In this embodiment, the MCU 28 recognizes whether the read command received from the host 100 is for music replay or not, as will be described later, and sets the music replaying flag 52. The MCU 28 also stores the history of past vibration detections and retries in the history storage area 53, and determines if a long time is required to complete the write process. If the MCU 28 determines that a long time is required for the write process in a music replay mode, the MCU 28 executes a read/write process for a music replay mode to be described later.

Music Replay Recognizing Process

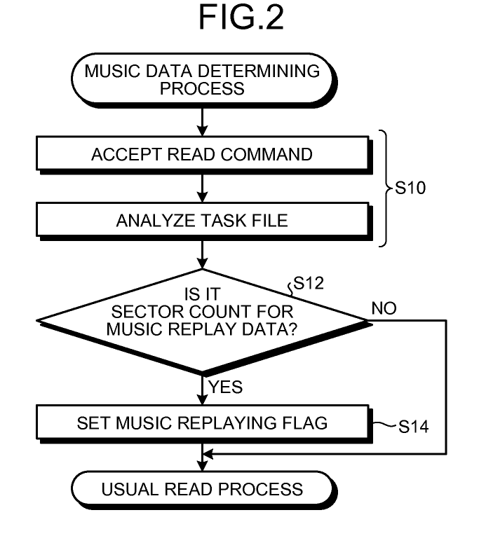

How the medium recording device recognizes the music replay mode will now be explained. The medium recording device can recognize the music replay mode independently, without relying on the music replaying application running on the host 100. FIG. 2 is a flowchart of a first embodiment of the music replay recognizing process according to the invention.

(S10) If the MCU 28 determines that the received command is a read command, the MCU 28 analyzes a task file in the command block. A task file specifies a previous command, a start logical block address (LBA), the number of requested sectors, and the like.

(S12) The MCU 28 further determines if the number of requested sectors specified in the task file is for music replay data. Usually, upon requesting replay of music, data in the fixed number of sectors are requested at a fixed interval. If the MCU 28 determines that the number of requested sectors specified in the task file is not for music replay data, the MCU 28 starts executing a usual read process, without setting the music replaying flag 52.

(S14) If the MCU 28 determines that the number of requested sectors specified in the task file is for music replay data, it means that the host 100 is in the music replay mode. Therefore, the MCU 28 sets the music replaying flag 52, and starts executing a usual read process.

As described above, to replay music, the host 100 requests data in the fixed number of sectors that is different from other situations. Therefore, the medium recording device can recognize independently that the host 100 is in the music replay mode based on the number of requested sectors.

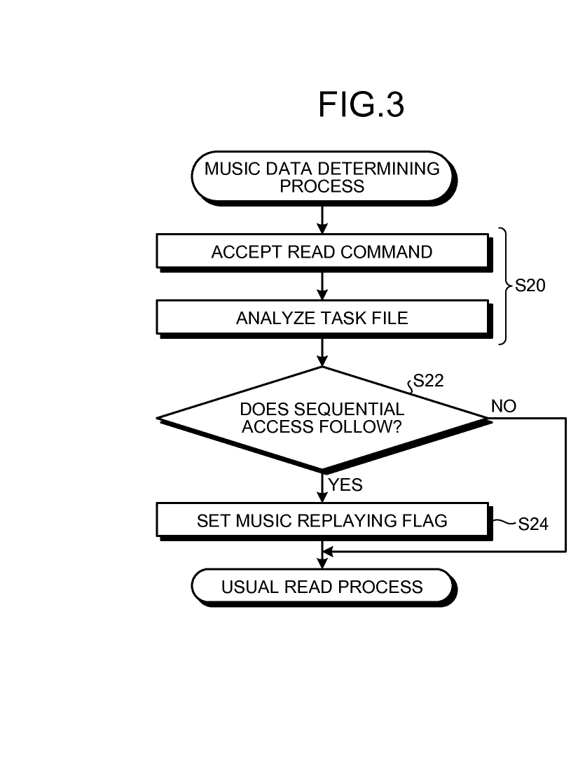

FIG. 3 is a flowchart of a second embodiment of the music replay recognizing process according to the invention.

(S20) If the MCU 28 determines that the received command is a read command, the MCU 28 analyzes the task file in the command block. A task file specifies a previous command, a start LBA, the number of requested sectors, and the like.

(S22) The MCU 28 further determines if the access is sequential. In other words, the MCU 28 determines whether the read commands are issued continuously within a predetermined period of time, and whether each of these read commands is issued at a fixed interval or not, based on the relationship in time when the previous read command is received and when the current read command is received. As mentioned earlier, when requesting music replay, the host 100 usually requests data in the fixed number of sectors at a fixed interval. If the MCU 28 determines that the access is not sequential, the MCU 28 starts executing a usual read process, without setting the music replaying flag 52.

(S24) If the MCU 28 determines that the access is sequential, the host 100 is in the music replay mode. the MCU 28 sets the music replaying flag 52, and starts executing the usual read process.

As described above, to replay music, the host 100 issues read commands at a fixed interval. Therefore, the medium recording device can recognize that the host 100 is in a music replay mode, based on the intervals between the read commands (a pattern in which the commands are issued).

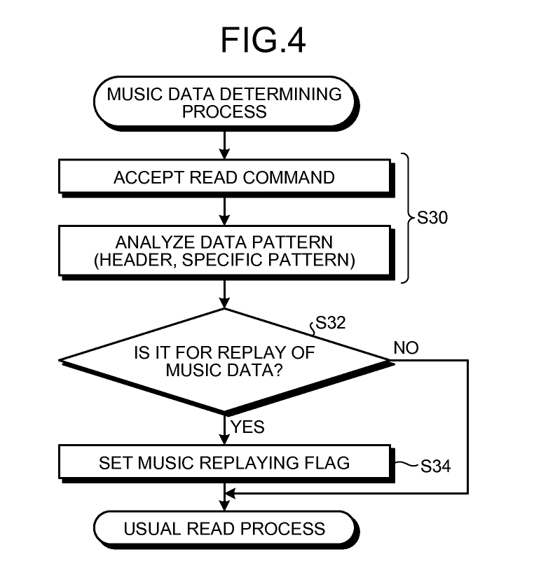

FIG. 4 is a flowchart of a third embodiment of the music replay recognizing process according to the invention.

(S30) If the MCU 28 determines that the received command is a read command, the MCU 28 performs data pattern analysis. In other words, the MCU 28 analyzes the header of the data to be read to determine if the header has a pattern that is specific to music data.

(S32) The MCU 28 determines if the pattern of the requested data is music-data specific. Music data has, at the head thereof, a specific pattern, such as a frame number or time. If the MCU 28 determines that the pattern of the requested data is not music-data specific, the MCU 28 starts executing the usual read process without setting the music replaying flag 52.

(S34) If the MCU 28 determines that the pattern of the requested data is music-data specific, the host 100 is in the music replay mode. Therefore, the MCU 28 sets the music replaying flag 52, and starts executing the usual read process.

As described above, because music data has a specific pattern at the head thereof (e.g., frame numbers and time), when the host 100 replays music, the medium recording device can recognize independently that the host 100 is in the music replay mode based on the music data pattern.

### First Embodiment of Read/Write Process

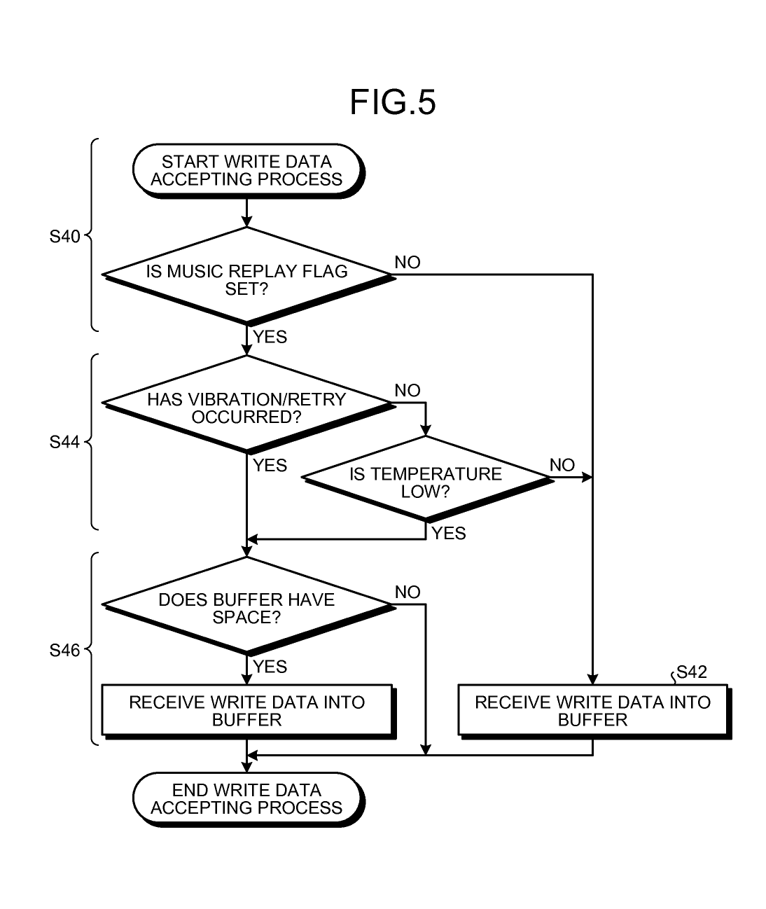

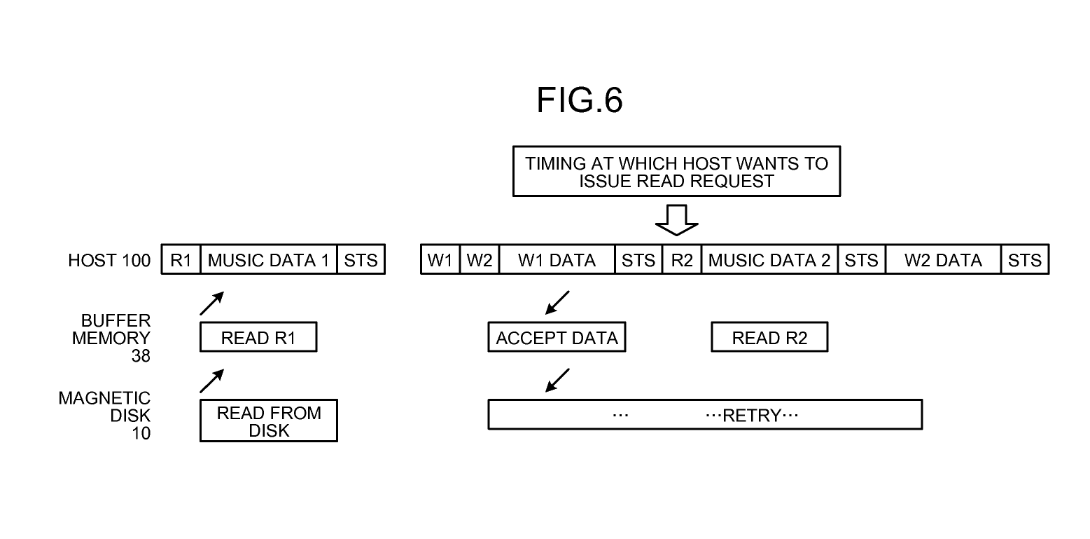

FIG. 5 is a flowchart of a first embodiment of a read/write process according to the invention, and FIG. 6 is a timing chart of the process illustrated in FIG. 5.

(S40) Upon receiving a write command from the host 100, the MCU 28 starts a write data accepting process. The MCU 28 first determines if the music replaying flag 52 is set.

(S42) If the music replaying flag 52 is not set, the host 100 is not replaying music. Therefore, the MCU 28 requests the write data to the host 100, receives the write data from the host 100, and stores the write data in the buffer memory (cache memory) 38. The MCU 28 then ends the write data accepting process.

(S44) If the music replaying flag 52 is set, the host 100 is replaying music. Therefore, the MCU 28 refers to the history storage area 53, and determines if the previous write process required a long time to be processed. In other words, because the history storage area 53 stores therein the history of vibrations or a retry occurrence in the past, the MCU 28 can determine if the previous write process required a long time to be processed by referring to the history storage area 53. If the MCU 28 refers to the history storage area 53 and determines that the previous write process did not require a long time to be processed, the MCU 28 detects a temperature by way of a temperature sensor not illustrated. The MCU 28 compares the detected temperature with a reference threshold for detecting a low temperature, and determines if the temperature is low. Because the maintaining force of the magnetic disk 10 is temperature dependent, when the temperature is low, the maintaining force increases and may cause the write to fail, increasing the possibility of a retry occurrence. Thus, the MCU 28 checks the temperature. If the temperature is not low, the MCU 28 proceeds to S42.

(S46) On the contrary, if it is determined that the previous write process required a long time to be processed or that the temperature is low at S44, the write process will possibly fail, and a retry will possibly occur. Therefore, the MCU 28 further determines if the buffer memory 38 has a space for storing therein the data that is requested by the write command. If the MCU 28 determines that the space is available for storing therein the data requested by the write command, the MCU 28 requests the write data to the host 100, receives the data therefrom, and stores the data in the buffer memory 38. The MCU 28 then ends the write data accepting process.

On the contrary, if the MCU 28 determines that no space is available for storing therein the data requested by the write command, the MCU 28 sends the status to the host 100 without requesting the write data, and ends the write data accepting process.

To explain more specifically with reference to FIG. 6, if the MCU 28 receives a write command W1 from the host 100 while music is replayed and a space is available in the buffer memory 38, the MCU 28 requests the write data to the host 100, and the host 100 sends write data W1 Data in response. After the write data is stored in the buffer memory 38, the magnetic head 12 writes the write data onto the magnetic disk 10.

The MCU 28 subsequently receives a write command W2 from the host 100. At this time, if the write of the previous write data W1 Data has failed and a retry is being attempted, the buffer memory 38 no longer has a space. Therefore, the MCU 28 does not request the write data to the host 100. In this manner, the host 100 is allowed to issue a read command R2 for music replay, and read data R2 can be sent to the host 100 from the buffer memory 38.

In this manner, upon receiving a write command while music is replayed, the MCU 28 checks if there is any possibility of the write failing. If there is possibility of the write failing, the MCU 28 requests the data in an amount that can be stored in the buffer memory 38 and executes the write, without requesting write data any further.

Therefore, the MCU 28 can accept the read commands issued at a fixed interval, and transfers the read data to the host. At this time, the MCU 28 may obtain the read data from the buffer memory; or, alternatively, the MCU 28 may use the magnetic head 12 to read the data from the magnetic disk 10, because the MCU 28 will no longer receive write data, and the write retry can be delayed.

Therefore, even if the MCU 28 receives a write command while music is replayed, a reply to the read command can be prevented from delaying, and therefore, the replay on the host can also prevented from delaying. For the commanding, the Native Command Queuing (NC) of the Serial AT Attached (SATA) may be preferably used.

### Second Embodiment of Read/Write Process

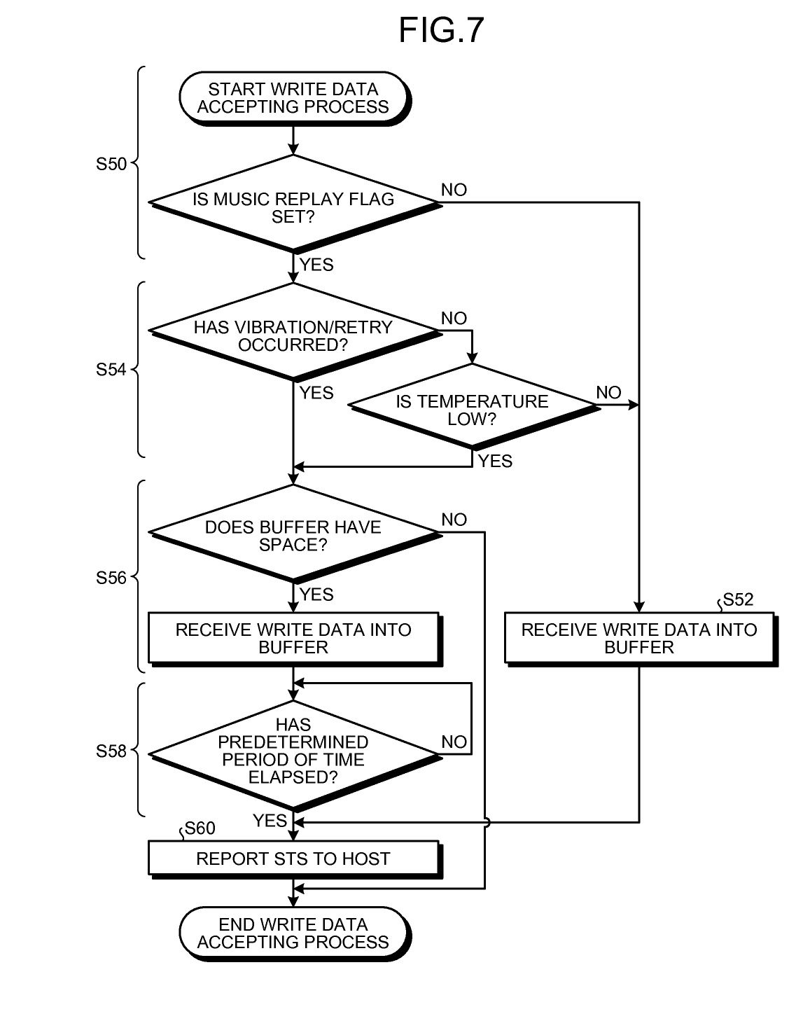

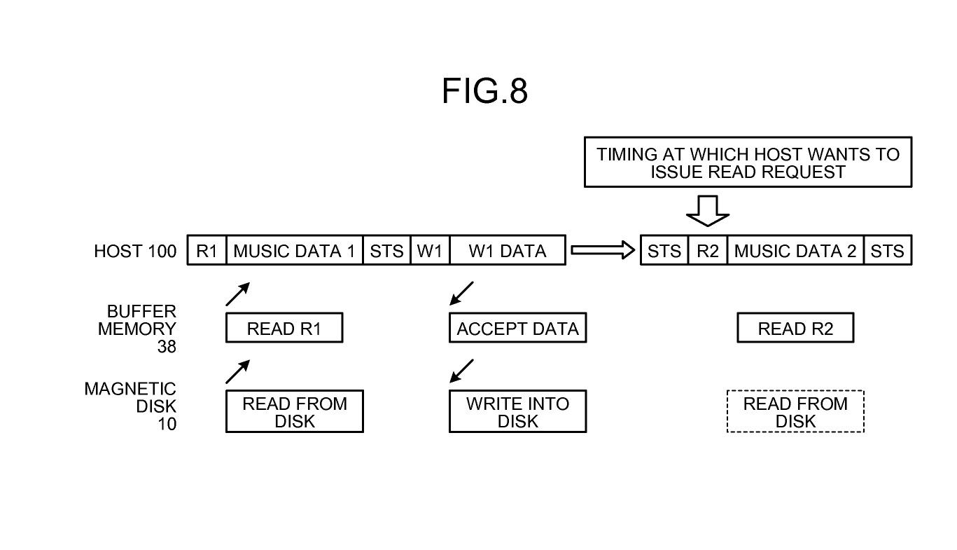

FIG. 7 is a flowchart of a first embodiment of the read/write process according to the invention, and FIG. 8 is a timing chart of the process illustrated in FIG. 7.

(S50) Upon receiving a write command from the host 100, the MCU 28 starts a write data accepting process. The MCU 28 first determines if the music replaying flag 52 is set.

(S52) If the music replaying flag 52 is not set, the host 100 is not replaying music. Therefore, the MCU 28 requests the write data to the host 100, receives the write data therefrom, and stores the write data in the buffer memory 38. The system control then proceeds to S60.

(S54) If the music replaying flag 52 is set, the host 100 is replaying music. Therefore, the MCU 28 refers to the history storage area 53, and determines if a previous write process required a long time to be processed. In other words, because the history storage area 53 stores therein the history of vibrations or a retry occurrence in the past, the MCU 28 can determine if the previous write process required a long time to be processed by referring to the history storage area 53. If the MCU 28 refers to the history storage area 53 and determines that the previous write process did not require a long time to be processed, the MCU 28 detects a temperature from a temperature sensor not illustrated. The MCU 28 compares the detected temperature with the reference threshold for detecting a low temperature, and determines if the temperature is low. Because the maintaining force of the magnetic disk 10 is temperature dependent, if the temperature is low, the maintaining force increases and may cause the write operation to fail, increasing the possibility of a retry occurrence. Thus, the MCU 28 checks the temperature. If the temperature is not low, the MCU 28 proceeds to S52.

(S56) On the contrary, if it is determined that the previous write process required a long time to be processed or that the temperature is low at S54, the write process will possibly fail, and a retry will possibly occur. Therefore, the MCU 28 further determines if the buffer memory 38 has a space for storing therein the data requested by the write command. If the MCU 28 determines that the space is available for storing therein the data requested by the write command, the MCU 28 requests the write data to the host 100, receives the data therefrom, and stores the data in the buffer memory 38. The MCU 28 then ends the write data accepting process. On the contrary, if the MCU 28 determines that no space is available for storing therein the data requested by the write command, the MCU 28 does not request the write data to the host 100.

(S58) The MCU 28 then determines if a predetermined period of time has elapsed since the last music data. In other words, the MCU 28 delays reporting the status (STS) of the write command until the timing the host 100 issues the read command for music replay. The MCU 28 maintains the timing at which the host 100 issues the read command upon setting the music replaying flag.

(S60) If the predetermined period of time has elapsed, the MCU 28 reports the status to the host 100, and ends the write data accepting process.

To explain more specifically with reference to FIG. 8, if the MCU 28 receives the write command W1 from the host 100 while music is replayed and a space is available in the buffer memory 38, the MCU 28 requests the write data to the host 100, and the host 100 sends write data W1 Data in response. After the write data is stored in the buffer memory 38, the magnetic head 12 writes the write data to the magnetic disk 10.

Regardless of the writing operation to the medium, the MCU 28 reports the status to the host 100 when the predetermined period of time has elapsed. In this manner, the host 100 can issue the read command R2 for music replay, and the read data R2 can be sent to the host 100 from the buffer memory 38 or the magnetic disk 10.

At this time, even if the write process for the write data W1 Data fails and a retry occurs, the host 100 can issue the read command R2 for music replay, and the read data R2 can be transferred to the host 100 from the buffer memory 38.

In this manner, upon receiving a write command, the MCU 28 checks for a possibility of the write failing; requests the data in an amount that can be stored in the buffer memory 38 if there is any possibility of the write failure, executes the write process; requests no more write data; and reports the status when the read command is repeated.

Therefore, the MCU 28 can accept the read commands that are issued at a fixed interval, and transfer the read data to the host. At this time, the MCU 28 may obtain the read data from the cache memory. Alternatively, the MCU 28 may use the magnetic head 12 to read the data from the magnetic disk 10, because the MCU 28 will no longer receive write data, and the write retry can be delayed.

### Other Embodiments

In the embodiments described above, the medium recording device according to the invention is explained to be applied to a magnetic disk device; however, the medium recording device can also be applied to other types of disk devices, e.g., an optical disk or a device that uses a rotating disk. Furthermore, although the configuration of the controller illustrated in FIG. 1 is explained herein, other configurations may also be applied. Moreover, the possibility of the write failure is determined based on the history of the past; however, such possibility can be determined based on a current output from the vibration sensor. Furthermore, an example of music replay is used herein; however, the invention may be applied to replay of any continuous data, such as dynamic image replay, e.g., videos.

According to the embodiment of the invention, the controlling circuit recognizes, by way of the received read command, that the read command is a read command issued by the host at a fixed interval for replaying continuous data; determines whether a write command received during the replay is likely to fail; and permits a reception of the read command issued at the fixed interval, while music or a video is replayed, when the write command is likely to fail. Therefore, an acceptance and processing of a read command can be prevented from being delayed by the delayed processing of a write command sent between the read commands. In this manner, the music or video replay can be prevented from skipping.

The various modules of the systems described herein can be implemented as software applications, hardware and/or software modules, or components on one or more computers, such as servers. While the various modules are illustrated separately, they may share some or all of the same underlying logic or code.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A medium recording device comprising:
a reading and writing module configured to read data from a recording medium and to write data to the recording medium;
a buffer memory configured to temporarily store data read by the reading and writing module and data to be written received from a host; and
a controller configured to read data from the buffer memory or from the recording medium and to transfer the data to the host in response to a read command, and to store data from the host in the buffer memory, to write the data onto the recording medium in response to a write command issued by the host, and to retry writing when the writing fails, wherein
the controller is configured to detect that the received read command is issued by the host at a fixed interval for replaying continuous data, and to determine whether the writing in response to the received write command during the replaying is likely to fail, and to permit a reception of the read command issued at the fixed interval when it is determined that the writing is likely to fail.

2. The medium recording device of claim 1, wherein the controller is configured to determine whether the buffer memory comprises a space for storing data to be written requested by the write command when it is determined that the writing is likely to fail, to request data to be written to the host when it is determined that the space is available, to store the data in the buffer memory, and to permit the reception of the read command issued at the fixed interval.

3. The medium recording device of claim 2, wherein the controller is configured to determine whether the buffer memory comprises a space for storing data to be written requested by the write command when it is determined that the writing is likely to fail, to prohibit requesting the data to be written to the host when it is determined that the space is unavailable, and to permit the reception of the read command issued at the fixed interval.

4. The medium recording device of claim 2, wherein the controller is configured to store the data to be written in the buffer memory, to execute the writing, and to wait for the read command issued at the fixed interval.

5. The medium recording device of claim 1, wherein the controller is configured to detect that the read command is for the replaying based on a size of data requested by the read command.

6. The medium recording device of claim 1, wherein the controller is configured to analyze a pattern in the issued read command and to detect that the read command is for the replaying.

7. The medium recording device of claim 1, wherein the controller is configured to determine a likelihood of the writing failure based on a history of writing failures in past.

8. The medium recording device of claim 7, wherein the controller is configured to determine the likelihood of the writing failure based on at least one of a history of retries of the writing and a history of vibrations applied to the device.

9. The medium recording device of claim 1, wherein the controller is configured to determine a likelihood of the writing failure based on an ambient temperature of the device.

10. The medium recording device of claim 1, wherein the controller is configured to determine a likelihood of the writing failure based on whether vibrations have been applied to the device.

11. A read and write processing method for a medium recording device, the method comprising:
either reading data from a buffer memory, or causing a medium reading and writing module to read data from a recording medium in response to a read command issued by a host, and transferring the data to the host;
storing data received from the host in the buffer memory in response to a write command issued by the host, and causing the medium reading and writing module to write the data onto the recording medium, and retrying the writing when the writing fails;
detecting that the received read command is issued by the host at a fixed interval for replaying continuous data;
determining whether the writing in response to the received write command during the replaying is likely to fail; and
permitting a reception of the read command issued at the fixed interval when it is determined that the writing is likely to fail.

12. The read and write processing method of claim 1, the method further comprising:
determining whether the buffer memory comprises a space for storing data to be written requested by the write command when it is determined that the writing is likely to fail; and
requesting data to be written to the host, storing the data in the buffer memory, and permitting the reception of the read command issued at the fixed interval, when the space is available.

13. The read and write processing method of claim 12, the method further comprising, prohibiting requesting the data to be written to the host and permitting the reception of the read command issued at the fixed interval, when it is determined that the space is unavailable.

14. The read and write processing method of claim 12, wherein the permitting comprises storing the data to be written in the buffer memory, executing the writing, and waiting for the read command issued at the fixed interval.

15. The read and write processing method of claim 11, wherein the detecting comprises detecting the read command to be for the replaying based on a size of data requested by the read command.

16. The read and write processing method of claim 11, wherein the detecting comprises analyzing a pattern in the issued read command and detecting that the read command is for the replaying.

17. The read and write processing method of claim 11, wherein the determining comprises determining a likelihood of the writing failure based on a history of writing failures in past.

18. The read and write processing method of claim 17, wherein the determining comprises determining the likelihood of the writing failure based on at least one of a history of retries of the writing and a history of vibrations applied to the device.

19. The read and write processing method of claim 11, wherein the determining comprises determining a likelihood of the writing failure based on an ambient temperature of the device.

20. The read and write processing method of claim 11, wherein the determining comprises determining a likelihood of the writing failure based on whether vibrations have been applied to the device.
